(19) United States
(12) Patent Application Publication
(10) Pub. No.: US 2010/0088224 A1
(43) Pub. Date: Apr. 8, 2010

(54) NATIONAL FORCLOSURE INTERVENTION AND PREVENTION METHODS AND FUTURE LENDING MODEL

(76) Inventor: RANDALL LOWELL, EDMONDS, WA (US)

Correspondence Address: Karr Tuttle Campbell;ATTN: PRIYA SINHA CLOUTIER, 1201 Third Ave., Ste 2900, Seattle, WA, 98101, US

(21) Appl. No.: 12/575,900

(22) Filed: Oct. 8, 2009

Related U.S. Application Data
(60) Provisional application No. 61/103,900, filed on Oct. 8, 2008.

(51) Int. Cl. G06Q 40/00

(52) U.S. Cl. 705/38

(57) ABSTRACT

Systems and methods are provided herein that provide for national foreclosure invention and prevention.

### CROSS-REFERENCES TO RELATED APPLICATIONS

This application claims priority to U.S. Application No. 61/103900, filed on 8 Oct. 2008, now pending, and hereby incorporates, by reference, that application in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BRIEF SUMMARY OF THE INVENTION

The present day foreclosure crisis began, in part, due to a housing bubble that was catalyzed by a combination of predatory lending a general lack of regulation of real estate lending practices. Specifically, sub-prime mortgages allowed borrowers to obtain loans where the borrowers would ultimately not be able to afford the loan payments. As these borrowers defaulted on their loans, the rate of foreclosures began to rise, which created turmoil in the real estate markets as well as other financial markets.

In March 2007, the United States' subprime mortgage industry collapsed due to higher-than-expected home foreclosure rates, with more than 25 subprime lenders declaring bankruptcy, announcing significant losses, or putting themselves up for sale. The stock of the country's largest subprime lender, New Century Financial, plunged amid Justice Department investigations, before ultimately filing for Chapter 11 bankruptcy on Apr. 2, 2007 with liabilities exceeding $100 million. The manager of the world's largest bond fund PIMCO warned in June 2007 that the subprime mortgage crisis was not an isolated event and will eventually take a toll on the economy and whose ultimate impact will be on the impaired prices of homes.

Additionally, Bear Stearns funds, which once held over $20 billion in assets, lost billions of dollars on securities backed by subprime mortgages. H&R Block reported that it made a quarterly loss of $677 million on discontinued operations, which included subprime lender Option One, as well as write-downs, loss provisions on mortgage loans and the lower prices available for mortgages in the secondary market for mortgages. Bear Stearns pledged up to US$3.2 billion in loans on Jun. 22, 2007 to bailout one of its hedge funds that was collapsing because of bad bets on subprime mortgages.

In order to ease the rising credit crunch that resulted in the U.S. credit market, the chairman of the Federal Reserve Bank, Ben Bernanke, decided to lower the discount window rate, which is the lending rate between banks and the Federal Reserve Bank, by 50 basis points on Aug. 17, 2007. The Federal Reserve Bank stated that the recent turmoil in the U.S. financial markets raised the risk of an economic downturn.

The subprime mortgage crisis reached a critical stage during September 2008, characterized by severely contracted liquidity in the global credit markets and insolvency threats to investment banks and other institutions. On Sunday, September 14, it was announced that Lehman Brothers would file for bankruptcy after the Federal Reserve Bank declined to participate in creating a financial support facility for Lehman Brothers. The same day, the sale of Merrill Lynch to Bank of America was announced. The beginning of the week was marked by extreme instability in global stock markets, with dramatic drops in United States stock market values.

On September 16, the large insurer American International Group (MG), a significant participant in the credit default swaps markets suffered a liquidity crisis following the downgrade of its credit rating. The Federal Reserve, at AIG's request, and after MG has shown that it could not find lenders willing to save it from insolvency, created a credit facility for up to US$85 billion in exchange for an 79.9% equity interest, and the right to suspend dividends to previously issued common and preferred stock

In late 2008 The US government bailed out MG and other banks who participated in the sub-prime lending and investment; the name of that program is the Toxic Asset Recovery Project (“TARP”). The critics of TARP argue that government bailouts are irresponsible. They further argue that bailouts would only promote imprudence in the future.

Some economists say the bailout created a moral hazard that encourages future risky lending and borrowing by signaling that in extreme circumstances, the government will bailout bad lenders and borrowers. They further argue that government bailouts will only encourage more speculative activities in markets other than housing. Such bailouts may prolong the inevitable consequences of the housing crisis and exacerbate other financial crisis in the future.

In the coming years, option ARM mortgages are set to be recast, which poses an extreme threat to the United States economy. Many borrowers with such loans will experience a nearly 80% increase in the amount of their monthly loan payment. This could create a foreclosure crisis that is even greater in scale than the crisis of present day. Accordingly, it is imperative that a solution is found to the present and future foreclosure crisis so that integrity and stability of the United States and global economy can be regained.

It is an object of the present invention to seek to ameliorate the problems described above. Accordingly, one object of the present invention is to reverse and prevent instability and decline in national and global economies. Specifically, this includes real estate markets, lending markets, rental housing markets, stock markets, and the like. In one example, a large number of foreclosures can cause economic decline and instability, so it is one object of the present invention to reduce the number of houses that are foreclosed on.

In another example, persons affected by economic turmoil are more likely to suffer from stress and therefore potentially suffer panic, illness and depression. Moreover, economic turmoil typically results in an increase in crime, violence, and suicide among member of the public. Accordingly, a further object of the invention is to increase the wellbeing of the public by reducing stressors that directly affect a person in economic distress and societal problems that stem from economic turmoil and a feeling of disenfranchisement.

In a further example, investors are not likely to participate in economic rejuvenation if they are exposed to undue financial risk. Accordingly, it is a further object of the invention to mitigate investor exposure and concerns relating to offered investment products and the general stability and health of an economic system.

In yet another example, government assistance to remedy an economic crisis should help the greatest number of people, households and families with as little capital as possible. Accordingly, yet another object of the present invention is to provide solutions to economic crisis that reach a larger number of people than other possible solutions, while also requiring less capital than other possible solutions.

In a still further example, economic crisis can reduce confidence and create distrust in government, which can compound economic issues and make it difficult to reverse them. Accordingly, it is a still further object of the invention to provide effective and successful government programs and assistance that restore confidence in government.

In another example, the “American Dream,” as defined by many, is home ownership. Realizing such a momentous goal is made more difficult, especially for the lower-classes, when there is economic turbulence or if markets are not appropriately structured. Accordingly, it is another object of the present invention to provide the opportunity for people of all socioeconomic backgrounds to realize the dream of homeownership.

Additionally, once a present economic crisis has been abated or reversed, financial policies need to be put into place that prevent such an economic crisis from occurring again. Therefore, it is another object of the present invention to instate economic policy that prevents crisis and turmoil in national and global markets moving forward.

In one example, government funded economic “bailout” programs are very costly to taxpayers and may cause more economic issues in the future. Such programs are unreliable and may only act as a temporary solution, which may require additional and unforeseen funding in the future. Accordingly, it is an object of the present invention to provide a personal “bailout” program so that individuals have their own financial buffers and remedies in place to provide self-help solutions so that a government “bailout” program is not required.

In another example, average citizens typically lack appropriate education and access to information to allow them to make informed decisions about investing, saving, home ownership and the like. Making bad decisions relating to such important issues creates a liability to not only the individual, but also to national and world economies. Accordingly, it is an object of the present invention to provide targeted counseling and ongoing educational programs to people so that they can make informed financial decisions.

Similarly, predatory lending practices are identified as a primary cause of the present real estate, foreclosure, and overall economic crisis in the United States, and such practices create the possibility of a similar crisis in the future. Accordingly, another object of the present invention is to prevent and eliminate potential for predatory lending practices to exist in a real estate market.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is a diagram illustrating a loan origination routine in accordance with an embodiment of the present invention;

FIG. 2 is a flow diagram illustrating a loan origination routine in accordance with various embodiments, wherein an initial bond investment is obtained from the borrower;

FIG. 3 is a diagram illustrating actions taken by a borrower, a lender, and a bond account during borrower loan default in accordance with an embodiment of the present invention.

FIG. 4 is flow diagram illustrating a foreclosure prevention routine in accordance with various embodiments, where in bonds are liquidated to a pay a borrower's monthly loan payment when the borrower fails to pay the monthly loan payment.

It should be noted here that the disclosure and drawings herein use bond to refer to bonds or other debentures.

### DETAILED DESCRIPTION OF THE INVENTION

Illustrative embodiments presented herein include, but are not limited to, methods for national foreclosure intervention and prevention. Various embodiments are directed to methods for reversing a present foreclosure crisis by, inter alia, modifying existing loan terms, modifying terms relating to subordinate lenders, imposing an equity share requirement, and creating a set fee structure.

Additionally, other embodiments are directed to reversing a present foreclosure crisis and preventing a future foreclosure crisis by creating a loan product that features self-insuring bonds and a forced savings plan. Such loans are applicable to a refinance, to new purchase real estate loans, to owner occupied loans, to investor loans, and to both commercial and residential loans.

### Modification of Existing Loans

As discussed herein, various embodiments are directed to modifying loan terms, modifying terms relating to subordinate lenders, imposing an equity share requirement, and creating a set fee structure for existing real estate loans. Additionally, some embodiments include restructuring of a loan to include self insuring bonds and a forced savings plan.

In some embodiments, interest rate loan terms on an existing loan can be reduced to as low as 3.0% per year, and in other embodiments, loan terms can be reduced to various rates, which can include 1.0%, 1.5%, 2.0%, 2.5%, 3%, 3.5%, 4.0%, 4.5%, 5.0%, 5.5%, 6.0%, 6.5%, 7.0% and the like, which can include various integers or fractions there within. In some embodiments, such an interest rate reduction can be subsidized by a bond.

For example, a loan may have an interest rate of 7.0% per year, and a federal bond may be issued to subsidize 4.0% per year of interest of the 7.0% per year interest rate. Accordingly, a borrower would make loan payment that would be equivalent to 3% interest per year, with 4.0% interest being subsidized by the federal bond. In other examples, an interest rate subsidy can be more or less than 4.0%, and can include various values such as 1.0%, 1.5%,2.0%, 2.5%, 3%, 3.5%, 4.0%, 4.5%, 5.0%, 5.5%, 6.0%, 6.5%, 7.0%, and the like, which can include various integers or fractions therewithin. Such an interest rate subsidy may be desirable because a guaranteed interest rate may create more demand from investors and lenders to become associated with such loans. Accordingly, the availability of capital for loans may increase, which may be desirable when market conditions are such that liquidity is low.

In some embodiments, a bond may provide an interest rate subsidy for various defined time periods or for an indefinite period of time. For example, an interest rate subsidy may last for a term of 5 years, wherein a borrower would therefore pay a reduced interest rate for 5 years and then be required to pay the full interest rate at a time after 5 years. In some examples, the borrower may obtain a renewed subsidy, a subsidy extension, or the like. Such an extension or renewal may be the same amount as a previous subsidy or may be more or less than a previous subsidy.

In one embodiment, a bond can be a government or private bond having a preferred term of 5 years; however, in other embodiments, a government or private bond may have a term of 1 year, 2 years, 3 years, 4 years, 5 years, 6 years, 7 years, 8 years, 9 years, 10 years, and the like, which can include various integers therewithin. In other embodiments, one or more government or private bond offering, or a combination thereof may be utilized. Bonds may be issued by a federal, state, county, global or private entity.

Additionally, in some embodiments, a loan amortization term may be modified. For example a loan amortization term can be extended or reduced to a term of 10 years, 15 years, 20 years, 25 years, 30 years, 35 years, 40 years, 50 years, 60 years, and the like, which may include various integers therewithin. Such a loan amortization term modification may be more or less than a previous loan amortization term. Various other loan terms may also be modified in some embodiments. In one example a loan may be changed from a variable interest rate to a fixed interest rate.

In various embodiments, a loan may be modified to include a real estate equity sharing program. In such a program, the owner of a given piece of real estate would be required to assign the right to a portion of the equity in the real estate. For example, equity may be defined as the value of the real estate less all liabilities such as mortgages and other liens. In various embodiments, the value of real estate can be defined as the tax assessed value, an appraised value or original loan amount, and value can be defined as a future value or past value.

In one embodiment, a borrower may be required to assign 20% of equity in real estate in accordance with a loan modification. Such an assignment of 20% equity may be made to a single entity, such as a government entity, company or individual, or one or more entity or person. For example, borrowers may be required to assign 10% of equity to a government entity and 10% equity to a company. In another example, borrowers may be required to assign 10% equity to a company, 5% equity to a fist investor, and 5% to a second investor. It should be clear that various portions of equity can be assigned, which may be more or less than 20%.

Additionally, an equity share may be on a sliding scale based on time. For example, an equity share may increase over period of 5 years, with equity share being 4.0% within the first year, 8.0% within the second year, 12.0% within the third year, 16.0% within the fourth year, and coming up to 20.0% in the fifth year. It should be clear that such a sliding scale can be based on various time increments such as days, weeks, months, years, and the like. Additionally, such a sliding scale can be a linear increase, exponential increase, logistic increase, and the like. Additionally such an increase may be predicated on benchmarks or various defined occurrences.

In other embodiments, a loan can be modified to contain a qualified loan assumption clause. For example, a loan can be modified to allow various qualified persons or entities to assume the loan. Accordingly, such qualified persons would not be required to obtain a new loan to obtain real estate associated with a loan having a qualified loan assumption clause, but would instead be able to take the place of the holder of the loan. Qualifications to assume a loan may include various qualification criteria, which may include a defined debt-to-income ratio, a defined credit score, ability to verify income or employment, and the like.

Additionally, subordinate financing may be limited or restricted. For example, a borrower may not be permitted to obtain secondary, tertiary, quaternary, quinary, senary, septenary, octonary, nonary, denary, or other level of subordinate financing. In other embodiments, a borrower may be able to obtain such subordinate financing under limited circumstances or after a defined period of time has passed or after a defined event has occurred.

For example, a subordinate financer may be required to participate in a program such as borrower based bond initiative, or other borrower “self-bailout” plan as described herein. In another example, a borrower may be able to obtain subordinate financing 5 years from when a loan was modified or originated. Additionally, subordinate financing may be further limited based on the combined loan to value ratio (“CL TV”). For example, subordinate financing may only be obtained up to a maximum CL TV of 70%, 75%, 80%, 85%, 90%, 95% and the like.

Moreover, loan modification may also include removing subordinate lienholders, which mayor may not include providing compensation to such lienholders. For example, a secondary lienholder may receive 10% of the value of the secondary lien; tertiary lienholders may receive up to 5% of the value of the tertiary lien; and other lienholders may not receive any value. In various embodiments, subordinate lienholders may be selectively removed, or only some levels of lienholders may be allowed to remain associated with a given piece of real estate.

In some embodiments, only certain types of borrowers may be eligible for modification of their loan. Eligibility can be based on one or more factors. For example, borrowers with an adjustable rate mortgage may be qualified; borrowers with a stated income loan may be qualified, borrowers facing foreclosure may be qualified, borrowers that can prove employment may be qualified, borrowers that cannot prove income may be qualified; borrowers establishing occupancy of the real estate borrowed against may be qualified; borrowers who receive ownership and/or budget counseling prior to funding may be eligible; abandoned properties may not be eligible; properties sold at auction may not be eligible; properties that have been repossessed by a bank or other lender may not be qualified.

In one embodiment fees associated with a loan modification or loan origination may be defined flat-rate fees. For example, there may be a $1000 origination fee paid to the agent originating the loan; a processing fee of $250; a title fee of $300; and escrow fee of $300; and a miscellaneous fee of $100 that may be applied to any of these. It should be clear that any of these fees could be various other amounts or one or more of these fees may be absent.

Additionally, in some embodiments, such fees may remain the same regardless of loan size. Moreover, a condition of such loans may be that pre-defined fees are the only fees allowable on such a loan. Such a restriction may be desirable because junk-fees can be eliminated from a loan process and predatory lending can be eliminated or reduced because the origination fee associated with such loans can be the same regardless of loan size or loan product.

With regard to entities that can process such a loan, there may be restrictions regarding characteristics of such an entity. For example, a loan originator may be required to have a brick-and-mortar office established within the state that the real estate being financed is located. Such a restriction may be desirable because local and regional economies are more likely to be stimulated if they are originating more of these loans. Accordingly, local economies suffering a foreclosure crisis will originate more of these loans and therefore stimulate the local economy while also assisting the foreclosure crisis. Such synergy may make it more likely for such local economies to recover from an economic downturn caused by a foreclosure crisis.

If a borrower defaults on such a loan there may be various default provisions in place. For example, a default may cancel an equity sharing provision. In another example, there may not be a deficiency provision in regard to defaults. Additionally, a borrower defaulting on such a loan may be subject to an immediate deed in lieu of foreclosure provision that requires immediate conveyance of real property upon more than 90 days delinquency. In other embodiments, the period of delinquency before such a provision takes effect may be various period of time, such as 30 days, 60 days, 120 days, 150 days, and the like. Where such a provision is activated and an immediate deed in lieu of foreclosure is required, the former owner of the real estate may be required to quit the property within a 30 day period, or in some cases a shorter or longer period of time.

Where a default occurs, all monies recovered may be directed to an investor's equity share, may be directed to deficit reduction, may be directed to payment of a bond, a combination thereof, and the like. Such recovered monies may be directed based on various defined hierarchies.

### Origination of New Loans and Refinancing

As discussed above, some embodiments are directed to preventing a future foreclosure crisis by providing loan products that feature self-insuring bonds and a forced savings plan. Such loans are applicable to a refinance, to new purchase real estate loans, to owner occupied loans, to investor loans, and to both commercial and residential loans.

In some embodiments, such loan terms can be applied during modification or reformation. Additionally, in various embodiments, new loans or a refinancing loan may include any of the terms, provisions, requirements, eligibility requirements, and the like, as described herein regarding loan reformation or modification. Accordingly, such description is incorporated by reference as it relates to new loans or refinancing loans.

Typically, a borrower that puts down less than 20% of the appraised value or sales price when purchasing real estate is required to obtain private mortgage insurance (“PMI”). PMI is insurance that is payable to a lender or trustee of a pool of securities, but not to the borrower. PMI is insurance to offset losses associated with a lender not being able to recover its costs during a foreclosure. For an average $300,000 home loan, PMI can cost over $1,500 per year and require an initial payment of $4500, or 1.5% of the purchase price.

Unfortunately, PMI does not assist a borrower from entering foreclosure, and only provides compensation to a lender after foreclosure has occurred. Accordingly, various embodiments are directed to a loan product that replaces PMI with a forced-savings and self-insuring bond plan.

In some embodiments, instead of requiring PMI as a condition for loans with certain criteria, a borrower will be required to purchase bonds. For example, as with PMI, a borrower may be required to purchase an initial quantity of bonds, and then be required to purchase bonds regularly, such as on a monthly basis. In another example, an initial bond purchase may be required, but additional bond purchases may not be required. In one embodiment, a borrower may be required to purchase various securities, which may include stocks, shares of a mutual fund, and the like.

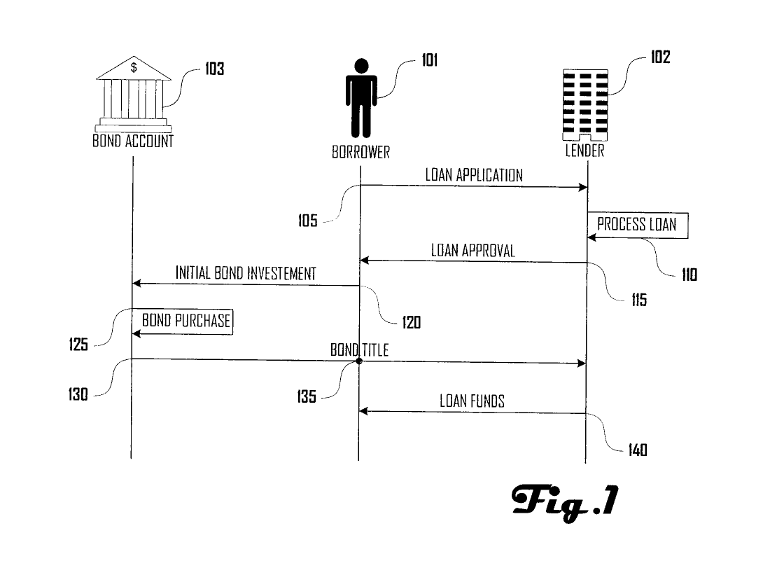

FIG. 1 is a pictorial diagram illustrating actions taken by a borrower 101, a lender 102 and a bond account 103 during loan origination in accordance with an embodiment of the present invention. The actions begin where the borrower 101 applies 105 for a loan. The lender 102 processes 110 the loan and sends 115 a loan approval back to the borrower 101. The borrower 101 initiates 120 an initial bond investment, bonds are purchased 125, and title to the bonds is sent 130 to the borrower 101 and sent 135 to the lender 102. The lender 102 then issues 140 loan funds to the borrower 101.

In various embodiments, one or more of the actions depicted in FIG. 1 can be performed by an escrow company, and attorney, or other agent on behalf of any of the parties or entities 101, 102, 103. For example, escrow may purchase 125 bonds on behalf of a borrower 101. Additionally, it should be clear that title need not be physically sent 130 to the borrower 101 or sent 135 to the lender 102 in various embodiments. For example, bonds can be purchased 125 in the name of a borrower 101 and a lender 102 and held in the bond account 103 in trust for the borrower 101 and lender 102. Moreover, one or more parties may be de-vested or vested from the bonds upon the occurrence of various events. For example, the lender 102 may be de-vested or removed from title on the bonds upon the expiration of a two year time period.

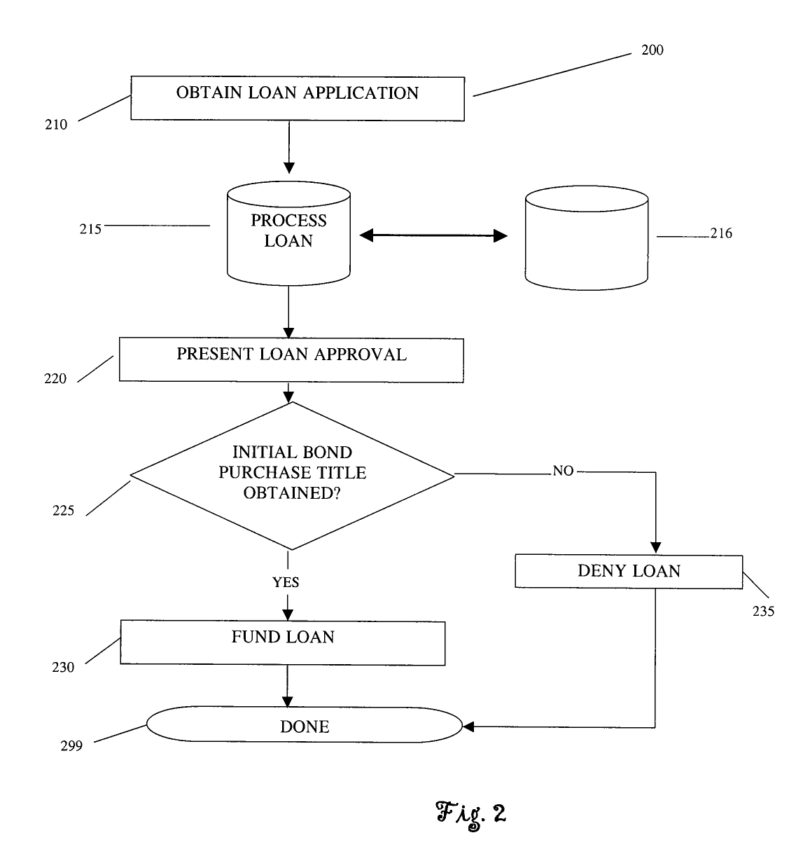

FIG. 2 is a flow diagram illustrating a loan origination routine 200 in accordance with various embodiments, wherein an initial bond investment is obtained from a borrower. The loan origination routine 200 begins in block 210 where a loan application is obtained and in block 215 the loan is processed using at least one processing system adapted to process information regarding the loan. Pertinent information regarding the loan is stored in a restricted database (116) specifically adapted to store said information. In block 220, a loan approval is presented to the borrower. In decision block 225 a determination is made whether an initial bond purchase title has been obtained, which indicates that the borrower has obtained borrower self-insuring bonds as required by the loan terms. If the bonds have not been obtained the loan origination routine 200 continues to block 235, where the loan is denied, and the loan origination routine 200 ends in block 299.

However, if title to the initial buyer bonds is obtained, the loan origination routine 200 continues to block 230 where the loan is funded, and the loan origination routine 200 ends in block 299.

In one embodiment, a borrower would be required to purchase an initial quantity of bonds, such as 1.5% of the purchase price, and subsequently purchase a defined quantity of bonds each month. For example, this quantity of bonds may be equal to, more than, or less the cost of a typical PMI policy.

In various embodiments, bonds purchased by a borrower may be held in the name of a lender and/or investor associated with the loan. This may be desirable because the lender can then have access to the bonds as collateral in case there is default by the borrower. For example, a lender/and or investor may jointly own securities within the borrower bond account, or the borrower may not have title to the securities. In other examples, a borrower may acquire title or acquire title absent ownership by an investor and/or lender after a defined period of time or after one or more defined event. Bonds may be withheld from the borrower for a period of years, until a loan-to-value amount is reached, if the borrower is not late on loan payments for a defined period of time, and the like.

In some embodiments, bonds may have a defined maturity date, and may be subject to a penalty if used before their maturity date. For example, a penalty could be 5.0%, 7.5%, 10.0%, 12.5%, 15.0% and the like.

In case of default or late payment by a borrower, bonds may be accessed by a borrower and/or investor in accordance with various embodiments. For example, if a borrower is late on a loan payment, a lender and/or investor may liquidate some of the bonds to pay the loan payment. This may be desirable because the lenders and investors can continue to obtain cash flow from loan payments instead of initiating a foreclosure on the borrower. Additionally, this may be desirable because borrowers would have a capital buffer to allow time to correct their financial situation, which may include finding employment, finding alternative financing, selling the property, and the like. Moreover, the borrower would not receive negative marks on the borrower's credits score, which would make it difficult to obtain alternate financing, find a job, rent a home, and the like.

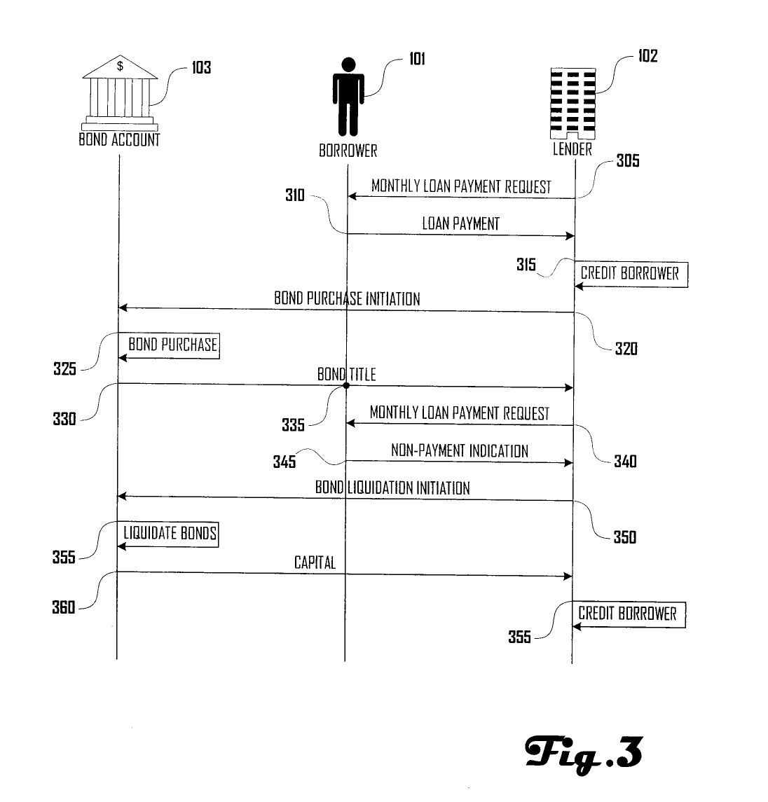

FIG. 3 is a pictorial diagram illustrating actions taken by a borrower 101, a lender 102 and a bond account 103 during borrower loan default in accordance with an embodiment of the present invention. In this exemplary embodiment, purchased 325 bonds are liquidated to pay a borrower's 101 monthly loan payment when the borrower 101 fails to pay the monthly loan payment.

The actions begin where a lender 102 sends 305 a monthly loan payment request to a borrower 101. The borrower 101 sends 310 a loan payment to the lender 102, which credits 315 the borrowers account. The lender 102 initiates 320 a bond purchase on behalf of the borrower 101, and bonds are purchased 325, and title is sent 330 to the borrower 101 and sent to the lender 102. It should be clear that in various embodiments, the lender 102 may initiate 320 a bond purchase 325 on behalf of a borrower 101 via escrow, an attorney or other agent. Additionally, as described above, physical title need not be sent to a borrower 101 and/or lender 102 relating to possession of bonds. In various embodiments, a lender 102 and borrower 101 may obtain a periodic statement relating to bonds owned or controlled by the borrower 101 and/or the lender 102.

Returning to the actions, the lender again requests 340 a monthly loan payment. However, instead of sending 315 a loan payment to the lender 102, the borrower 101 instead indicates 345 that the borrower 101 will not pay the monthly loan payment. For example, such an indication 345 may be in the form of a letter, telephone call, e-mail, text message, facsimile message, or an indication 345 by simply not responding to the monthly loan payment request 340.

The lender 102 initiates 350 bond liquidation and bonds are liquidated 355 from the borrower's bond account 103. Capital from the sale of the bonds is sent 360 to the lender 102, which may apply the capital to cover the borrower's 101 monthly loan payment that has not been paid. Accordingly, the lender 102 credits the borrower's 101 account as having been paid.

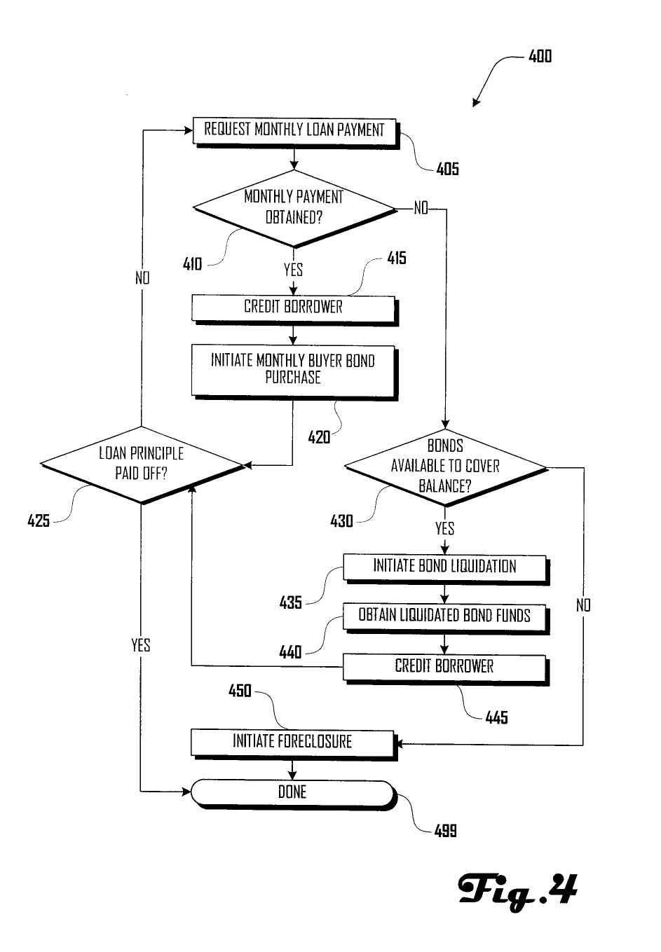

FIG. 4 is a flow diagram illustrating a foreclosure prevention routine 400 in accordance with various embodiments, wherein bonds are liquidated to pay a borrower's 101 monthly loan payment when the borrower 101 fails to pay the monthly loan payment.

The foreclosure prevention routine 400 begins in block 405 where a monthly loan payment is requested. In various embodiments, is may be in the form of a monthly bill or e-bill. In decision block 410, a determination is made whether the monthly payment is obtained.

If the monthly payment is obtained, the foreclosure prevention routine 400 continues to block 415 where the borrower's account is credited, and in block 420 a monthly buyer bond purchase is initiated. The foreclosure prevention routine 400 continues to decision block 425 where a determination is made whether the loan principle has been paid off. If so, the foreclosure prevention routine 400 ends in block 499. If the loan principle has not yet been paid off, the foreclosure prevention routine 400 cycles back to block 405, where the monthly loan payment is requested in the following month.

Returning to decision block 410, if it is determined that the monthly payment has not been received, the foreclosure prevention routine 400 continues to block 430, where a determination is made whether bonds are available to cover the balance of the borrowers overdue account. If there are not bonds to cover the balance, the foreclosure prevention routine 400 continues to block 450 where foreclosure is initiated and the foreclosure prevention routine 400 ends in block 499.

However, if there are bonds available to cover the balance, then bond liquidation is initiated in block 435 and in block 440 liquidated funds are obtained. In block 445, the borrowers account is credited as current by applying obtained funds to the borrowers account.

The foreclosure prevention routine 400 continues to block 425 where a determination is made whether the loan principle is paid off. If so, the foreclosure prevention routine 400 ends in block 499. If the loan principle is not paid off, then the foreclosure prevention routine 400 cycles back to block 405, where the next monthly payment is requested from the borrower.

In some embodiments, bonds may also be liquidated to recover costs associated with foreclosure. For example, if a lender or investor does foreclose on a borrower's property, the bonds held in the name of the lender and/or investor can be liquidated to recover costs associated with such a foreclosure. In some examples, a lender may be required to liquidate bonds to replace loan payments for a defined period of time before the lender is allowed to foreclose on the property and recover liquidate bonds to recover damages.

In the event that a borrower does not default, bonds held jointly or held by a lender and/or borrower may vest with the borrower. Accordingly, borrowers having title to such bonds would be able to use the bonds at their discretion; however, may be subject to a penalty if the bonds are utilized before a defined maturity date.

Various aspects of the illustrative embodiments have been described herein using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

Further, various operations and/or communications are described herein as multiple discrete operations and/or communications, in turn, in a manner that is most helpful in understanding the embodiments described herein; however, the order of description should not be construed as to imply that these operations and/or communications are necessarily order dependent. In particular, these operations and/or communications need not be performed in the order of presentation.

The phrase “in one embodiment” is used repeatedly. The phrase generally does not refer to the same embodiment; however, it may. The terms “comprising,” “having” and “including” are synonymous, unless the context dictates otherwise.

Additionally, although specific embodiments have been illustrated and described herein, it will be appreciated by those of ordinary skill in the art and others, that a wide variety of alternate and/or equivalent implementations may be substituted for the specific embodiments shown and described without departing from the scope of the embodiments described herein. This application is intended to cover any adaptations or variations of the embodiment discussed herein. While various embodiments have been illustrated and described, as noted above, many changes can be made without departing from the spirit and scope of the embodiments described herein.

What is claimed:

1. A method of foreclosure intervention and prevention comprising:
a. at least one restricted database adapted to store general information about at least one Borrower, at least one loan application, at least one bond investment, at least one Lender, and the terms and conditions of at least one funded loan;
b. at least one processing system adapted to process information regarding at least one loan application and the terms and conditions of at least one funded loan.
c. at least one Borrower initiating a loan with at least one Lender;
d. the at least one Lender stores the at least one Borrower's information in the at least one restricted data base;
e. the at least one Lender processes the at least one loan application;
f. the at least one Lender approves the at least one loan; the terms and conditions of the at least one loan requires periodic payment toward the loan by the at least one Borrower.

2. The method of claim 1 further comprises purchase of initial bond investment.

3. The title of the purchased bond investment in claim 2 is held is trust.

4. The method of claim 2 further comprises the at least one Lender funding the at least one loan.

5. The method of claim 4 further comprises additional bond investments at periodic intervals.

6. The method of claim 2 further comprises the at least on Borrower acquiring title to bond investment after a date certain.

7. The method of claim 5 further comprises the at least one Borrower acquiring bond investments after a date certain.

8. The method of claim 2 further comprises the at least one Borrower communicating with the at least one Lender that at least one periodic payment will not be made in accordance with the terms and conditions of the at least one loan.

9. The method of claim 8 further comprises the at least one Lender initiating liquidation of a set number of bond investments held in trust; capital from the liquidation of said bond investment is applied to the at least one unpaid periodic payment.

10. The method of claim 9 where the capital from the sale of said set number of bond investments completes the terms and conditions of the at least one loan then the at least one Borrower takes possession of any remaining bond investments.

11. The method of claim 9 where the capital from the sale of said set number of bond investments does not complete the terms and conditions of the at least one loan then, at the next set periodic payment date, the Borrower pays the Lender amounts due under the terms and conditions of the at least one loan.

12. The method of claim 9 further comprises the lender liquidating bond investments to pay fees, costs, or a combination thereof associated with the non-payment of the terms and conditions of the at least one loan.
